(19) United States
(12) Patent Application Publication
(10) Pub. No.: US 2012/0093193 A1
(43) Pub. Date: Apr. 19, 2012

(54) ELECTRONIC APPARATUS OF A DOWNHOLE TOOL

(75) Inventors: Emmanuel Desroques, Paris (FR); Sylvain Thierry, Le Mesnil St Denis (FR)

(73) Assignee: Schlumberger Technology Corporation

(21) Appl. No.: 13/263,073

(22) PCT Filed: Apr. 28, 2010
(86) PCT No.: PCT/EP2010/002624

§ 371 Date: Dec. 16, 2011

(30) Foreign Application Priority Data
May 7, 2009 (EP) 09159618.9

(51) Int. Cl. G01K 13/00

(52) U.S. Cl. 374/136; 374/E13.001

(57) ABSTRACT

An electronic apparatus (12) of a downhole tool (9, 11) comprises a first electronic device (13) operating up to a first maximum operating temperature, a second electronic device (14) operating up to a second maximum operating temperature, a switch (15) coupling the first electronic device (13) to the second electronic device (14), the second electronic device (14) providing electrical power to the first electronic device (13). The second maximum operating temperature is higher than the first maximum operating temperature. The switch (15) is a thermally controlled switch such that the switch is only closed when a measured temperature of the first electronic device is lower than the first maximum operating temperature.

### FIELD OF THE INVENTION

The invention relates to an electronic apparatus for a downhole tool and in particular, but not exclusively to a drilling environment.

### BACKGROUND OF THE INVENTION

FIG. 1 schematically shows a typical onshore hydrocarbon well with surface equipment 1, which is located above a hydrocarbon geological formation 2 after some well-bore 3 drilling operations have been carried out.

A first portion 4 of the well-bore is a cased portion. A casing string 5 has been run into this first portion of the well-bore. Cementing operations have been carried out, in this first portion, for sealing the annulus (i.e. the space between the well-bore 3 and the casing string 5). A second portion 6 of the well-bore is an open bore hole. A third portion 7 of the well-bore is a sensibly horizontal lateral bore hole.

Typically, the surface equipment 1 comprises a plurality of mud tanks and mud pumps, a derrick, a draw-works, a rotary table, a power generation device and various auxiliary devices, etc. . . . which are well known in the oilfield industry domain. A drill string 8 couples the surface equipment with a downhole tool, for example a drilling assembly 9. The drilling assembly comprises a drill bit. The drill string and the drilling assembly comprise an internal conduit through which a drilling fluid 10 circulates.

The downhole tool may further comprise a logging assembly 11 for performing logging while drilling or measurement while drilling. Typically, the logging assembly comprises various sensors, power units, and processing units comprising numerous electronic components. Today's hydrocarbon wells reach depths where the temperature increases above the conventional maximum operating temperature of the electronic components like sensors, low noise electronic modules, and complex processor, etc. . . . used in the downhole tool. Typically, the conventional maximum operating temperature of standard Silicon integrated circuit is 200° C. The drilling fluid circulating inside the internal conduit is used on the one side to cool down the electronic components, and on the other side to power the downhole tool by means of a turbine alternator. However, during certain period of time, the drilling fluid circulation is stopped. As a consequence, the power for the electronic component is shut down, and the temperatures of the static drilling fluid, the downhole tool and the electronic component increase. It is common to observe variations ranging in the tens of degrees of the temperature of the electronic component. As an example, in a hydrocarbon well for which the static temperature is reaching 220° C. at a determined depth, the temperature of the electronic components of the downhole tool can be cool down to 190° C. when the drilling fluid is circulating. Indeed, as soon as the drilling fluid circulation re-starts, the power comes up while there is a latency for the temperature to decrease under the maximum operating temperature. As a consequence, many failures of the electronic components occur shortly after the drilling fluid circulation re-starts. Thus, there is a need to avoid such temperature dependant failure.

### SUMMARY OF THE INVENTION

It is an object of the invention to propose an electronic apparatus for a downhole tool that overcomes at least one of the drawbacks of the prior art, in particular an electronic apparatus which is adapted for operation in harsh downhole environment.

One aspect of the invention relates to an electronic apparatus of a downhole tool comprising a first electronic device operating up to a first maximum operating temperature, a second electronic device operating up to a second maximum operating temperature, a switch coupling the first electronic device to the second electronic device, the second device providing electrical power to the first electronic device, the second maximum operating temperature being higher than the first maximum operating temperature, and the switch being a thermally controlled switch such that the switch is only closed when a measured temperature of the first electronic device is lower than the first maximum operating temperature.

Advantageously, the thermally controlled switch may be coupled to a temperature sensor measuring the temperature of the first electronic device.

Advantageously, the second electronic device may comprise a turbine alternator coupled to a rectification module, coupled to a power converter delivering the electrical power under the form of a rectified and stepped-down signal.

Advantageously, the first electronic device may comprise a standard Silicon integrated circuit.

Advantageously, the second electronic device may comprise a Silicon Carbide SIC device, or a Silicon on insulator SOI device, or a multichip module MCM, or a combination of anyone of them.

Advantageously, the first maximum operating temperature may be 200° C. and the second maximum operating temperature may be 250° C.

Another aspect of the invention relates to a dowhole tool comprising an electronic apparatus according to the invention.

Still another aspect of the invention relates to a method for operating an electronic apparatus of a downhole tool, the method comprising measuring a temperature of the first electronic device, and coupling the first electronic device to the second electronic device such that the second electronic device provides electrical power to the first electronic device only when the measured temperature of the first electronic device is lower than the first maximum operating temperature.

The invention enables avoiding the temperature dependant failures of prior art electronic apparatus. The operating range of the downhole tool is extended such that the electronic apparatus can survive temperature well above the maximum operating temperature of the electronic components while only operating tens of degrees below.

### BRIEF DESCRIPTION OF THE DRAWINGS

The present invention is illustrated by way of example and not limited to the accompanying figures, in which like references indicate similar elements:

FIG. 1 schematically shows a typical onshore hydrocarbon well location;

FIG. 2 is a block diagram schematically representing an electronic apparatus for a downhole tool according to the invention;

FIG. 3 is a block diagram schematically representing an exemplary embodiment of the thermally controlled switch; and

FIG. 4 illustrates operation of the electronic apparatus of the invention.

### DETAILED DESCRIPTION OF THE INVENTION

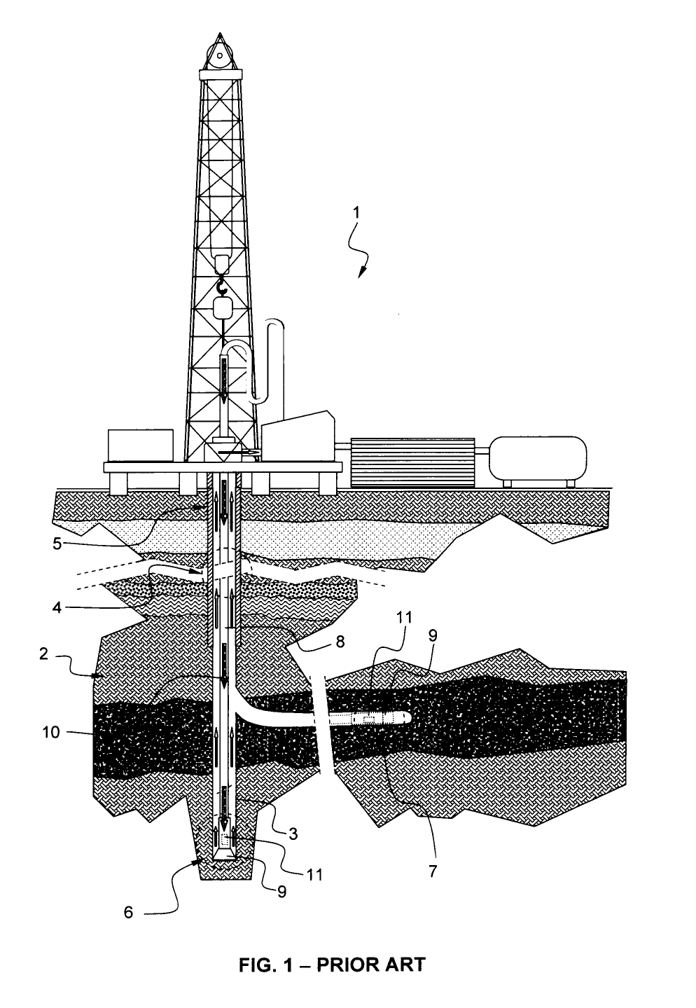

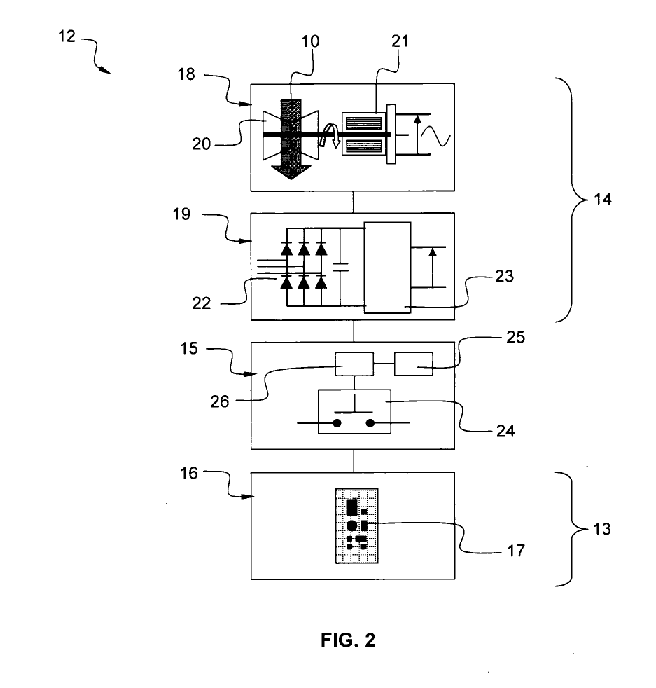

FIG. 2 is a block diagram schematically representing an electronic apparatus 12 for a downhole tool (9 and 11 shown in FIG. 1). For example, the electronic apparatus 12 may be a part of the logging assembly (11 shown in FIG. 1). The electronic apparatus 12 comprises a first electronic device 13, a second electronic device 14 and a thermally controlled switch 15.

The first electronic device 13 may comprise a printed circuit board 16 comprising various electronic components 17. For example, the electronic components 17 may be sensors, processors, memories. The sensors may be used to measure properties of the geological formation, the well bore, the drilling fluid, etc. . . . Alternatively, the first electronic device 13 may comprise a plurality of printed circuit board or Multi-chip modules (MCM). The first electronic device 13 operates up to a first maximum operating temperature, for example 200° C. As an example, the first electronic device is implemented by using a standard Silicon integrated circuit technology.

The second electronic device 14 provides electrical power to the first electronic device 13. The second electronic device 14 may comprise an electrical energy generator 18 coupled to a power supply 19. The electrical energy generator 18 may comprise a turbine 20 coupled to an alternator 21. The turbine 20 rotates when the drilling fluid 10 is circulated into the drill string and downhole tool. Thus, the alternator 21 driven by the turbine 20 generates and alternative signal. The alternative signal delivered by the alternator 21 is delivered to the power supply 19. The power supply 19 may comprise a rectification module 22 coupled to a power converter 23. As an example, the rectification module 22 comprises a Graetz bridge, and the power converter 23 comprises a rectifier and a step-down converter. The power supply 19 delivers an electrical power under the form of a rectified and stepped-down signal (voltage and/or current) suitable for the operation of the first electronic device 13. Advantageously, the second electronic device 14 operates up to a second maximum operating temperature, for example 250° C., at least 220° C. The second maximum operating temperature is higher than the first maximum operating temperature. As an example, the second electronic device is implemented by using a Silicon Carbide SiC device technology, or a Silicon on insulator SOI device technology, or a multichip module MCM technology. It may also be implemented by using a combination of the above mentioned technologies.

The thermally controlled switch 15 couples the first electronic device 13 to the second electronic device 14. The thermally Controlled switch 15 comprises a switch 24, a temperature sensor 25 and switching module 26. The switch 24 couples the first device 13 to the second device 14. The temperature sensor measures the temperature of the first electronic device 13. Alternatively, the temperature sensor 25 measures the temperature in the vicinity of the first electronic device 13, said temperature being representative of the actual temperature of the first electronic device 13. The switching module 26 operates the switch 24 in dependence of the measured temperature by the temperature sensor 25. For instance, the switch is closed when a measured temperature of the first electronic device 13 is lower than the first maximum operating temperature, e.g. 200° C. Conversely, the switch is open when a measured temperature of the first electronic device 13 is higher than the first maximum operating temperature, e.g. 200° C. Thus, the thermally controlled switch 15 controls supplying electrical power to the electronic device such as to avoid failure due to temperature exceeding the maximum operating temperature of the electronic components of the first electronic device 13. In other word, the electronic components of the first electronic device 13 are only powered up when the temperature is below a predefined temperature.

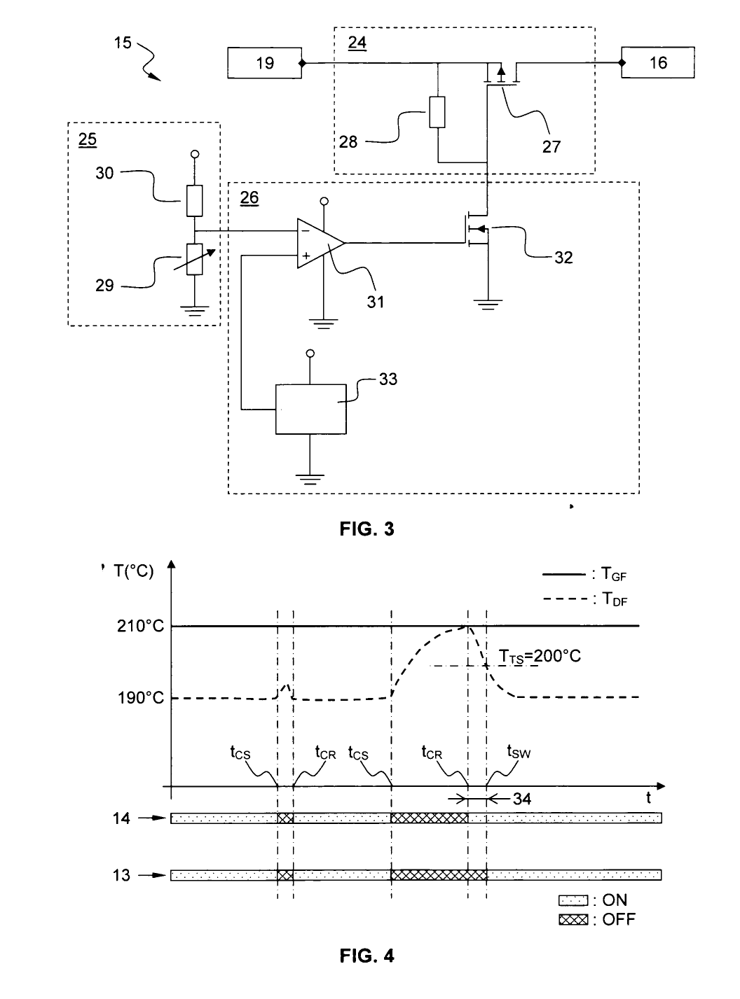

FIG. 3 is a block diagram schematically representing an exemplary embodiment of the thermally controlled switch 15 that may be used in the electronic apparatus 12 of FIG. 2.

The switch 24 comprises a transistor PMOS 27 (MOSFET metal oxide semiconductor field effect transistor) of the P type. The source of the transistor is connected to the power supply 19. The drain of the transistor PMOS 27 is connected to the printed circuit board 16. The gate of the transistor PMOS 27 is connected to the switching module 26. A second resistor 28 of appropriate resistance value is connected between the source and the gate of the transistor PMOS 27.

The temperature sensor 25 comprise a Platinum resistor 29 connected to the ground and a first resistor 30 of appropriate resistance value. The Platinum resistor 29 is further connected to the switching module 26.

The switching module 26 comprises a reference voltage 33, a comparator 31 and a transistor NMOS 32. The voltage reference 33 and the temperature sensor 25 are connected to the comparator 31 input. The voltage reference 33 is chosen such as to define the switching temperature. Advantageously, the switching temperature is below the maximum operating temperature of the electronic components of the printed circuit board 16 (first electronic device 13). The transistor NMOS 32 (MOSFET metal oxide semiconductor field effect transistor) is of the N type. The output of the comparator is coupled to the gate of the transistor NMOS 32. The source of the transistor NMOS 32 is connected to the ground. The drain of the transistor NMOS 32 is connected to the switch 24, namely the gate of the transistor PMOS 27 of the switch 24. Thus, when the temperature near the Platinum resistor 29 is below the switching temperature, the switching module 26 controls the switch in a closed position. As a consequence, the power supply 19 is coupled to the printed circuit board 16 which is powered-up. Further, when the temperature near the Platinum resistor 29 is above the switching temperature, the switching module 26 controls the switch in an opened position. As a consequence, the power supply 19 is decoupled of the printed circuit board 16 which is shut-off.

The elements of the thermally controlled switch 15 are implemented in a Silicon Carbide SiC device technology, or a Silicon on insulator SOI device technology, or a multichip module MCM technology, or a combination of the hereinbefore mentioned technologies.

FIG. 4 illustrates an example of operation of the electronic apparatus of the invention. The graphic of FIG. 4 shows the temperature of the geological formation T_{GF} (full line) surrounding the downhole tool in dependence of time t. In the present example, this temperature T_{GF} is static around 210° C. The graphic also shows the temperature of the drilling fluid T_{DF} (broken line) circulating into the downhole tool in dependence of time t. In the present example, this temperature T_{DF} is around 190° C. when the drilling fluid is circulating and increases to the static temperature of geological formation T_{GF} when the circulation is stopped. When the drilling fluid is not circulating (t=t_{CS}), the turbine and alternator are not running, and the power supply and the thermally controlled switch are shut down (14 OFF). When the drilling fluid is circulating, the turbine and alternator are running, the power supply and the thermally controlled switch are powered-up (14 ON). On the one hand, the switch couples the power supply to the printed circuit board only if the measured temperature of the printed circuit board is below a predefined temperature (T_{TS}=200° C.) preferably below the maximum operating temperature of the electronic components of the printed circuit board. On the other hand, the printed circuit board is un-powered if the measured temperature of the printed circuit board is above said predefined temperature, preferably just below the maximum operating temperature of the electronic components of the printed circuit board. In this case, as the electronic components of the printed circuit board are un-powered, there is no risk of failure and no self heating effect. In the situation where the circulation of the drilling fluid is resumed (t=t_{CR}) after having been stopped (t=t_{CS}), the drilling fluid circulating inside the downhole tool cool down the temperature inside the downhole tool with a certain latency 34. When the temperature reaches the predefined temperature value T_{TS}, the thermally controlled switch couples the printed circuit board to the power supply and the electronic components are powered (t=t_{SW}). Nevertheless, a sine-qua-non condition remains that although un-powered, the electronic components of the printed circuit board has to survive the high temperature environment.

Though the invention has been described in relation with a particular example of onshore hydrocarbon well location, it will also be apparent for a person skilled in the art that the invention is applicable to offshore hydrocarbon well location.

The drawings and their description hereinbefore illustrate rather than limit the invention.

Any reference sign in a claim should not be construed as limiting the claim. The word “comprising” does not exclude the presence of other elements than those listed in a claim. The word “a” or “an” preceding an element does not exclude the presence of a plurality of such element.

1. An electronic apparatus of a downhole tool comprising:
a first electronic device operating up to a first maximum operating temperature,
a second electronic device operating up to a second maximum operating temperature, and
a switch coupling the first electronic device to the second electronic device, the second electronic device providing electrical power to the first electronic device,
wherein:
the second maximum operating temperature is higher than the first maximum operating temperature, and
the switch is a thermally controlled switch such that the switch is only closed when a measured temperature of the first electronic device is lower than the first maximum operating temperature.

2. The electronic apparatus of claim 1, wherein the thermally controlled switch is coupled to a temperature sensor measuring the temperature of the first electronic device.

3. The electronic apparatus of claim 1, wherein the second electronic device comprises a turbine alternator coupled to a rectification module, coupled to a power converter delivering the electrical power under the form of a rectified and stepped-down signal.

4. The electronic apparatus of claim 1, wherein the first electronic device comprises a standard Silicon integrated circuit.

5. The electronic apparatus of claim 1, wherein the second electronic device comprises a Silicon Carbide (SiC) device, or a Silicon on insulator (SOI) device, or a multichip module (MCM), or a combination of anyone of them.

6. The electronic apparatus of claim 1, wherein the first maximum operating temperature is about 200° C. and the second maximum operating temperature is about 250° C.

7. A downhole tool comprising an electronic apparatus according to claim 1.

8. A method for operating an electronic apparatus of a downhole tool, the electronic apparatus comprising a first electronic device operating up to a first maximum operating temperature and a second electronic device operating up to a second maximum operating temperature, the second maximum operating temperature is higher than the first maximum operating temperature, the method comprising:
measuring a temperature of the first electronic device, and
coupling the first electronic device to the second electronic device such that the second electronic device provides electrical power to the first electronic device only when the measured temperature of the first electronic device is lower than the first maximum operating temperature.
